(19) United States
(12) Patent Application Publication
(10) Pub. No.: US 2013/0090491 A1
(43) Pub. Date: Apr. 11, 2013

(54) PHENOL-FREE PHOSPHITES DERIVATIVES AND PREPARATION THEREOF

(71) Applicants: Kuang Hsu HUANG, Taipei (TW); Chin-Fu Huang, Taipei (TW)

(72) Inventors: Kuang Hsu HUANG, Taipei (TW); Chin-Fu Huang, Taipei (TW)

(21) Appl. No.: 13/331,015

(22) Filed: Dec. 20, 2011

(30) Foreign Application Priority Data
Oct. 7, 2011 (TW) 100136445

(51) Int. Cl. C07F 9/145

(52) U.S. Cl. 558/95; 558/156; 558/114

(57) ABSTRACT

The present invention relates to phenol-free phosphites and preparation thereof. The phenol-free phosphites are obtained by reacting biphenol, and phosphorous derivatives with higher aliphatic alcohol via condensation and trans-esterification. The phenol-free phosphites of the present invention can be used as a heat stabilizer for resin so as to enhance the heat resistance of the resin during processing at high temperatures.

### FIELD OF THE INVENTION

The invention relates to phenol-free phosphites derivatives and preparation thereof, in particular to phosphites derivatives which are useful as heat-stabilizer for organic polymer and contains residual phenol leveling an amount of 0.5 wt % or less, and their preparation thereof.

### BACKGROUND OF THE INVENTION

Polymer resin such as polyvinylchloride (PVC) would easily deteriorate (i.e., brittleness, discoloration or haziness) when it is processed or exposed to radiation, heat and oxidation state due to its poor heat-resistance. Therefore, by considering some physical or chemical properties and economical requirement, the resin is usually added with some additives to achieve the purpose required. Generally, there are many kinds of additives depending on the purposes, such as lubricant, heat stabilizer, nucleating agent, reinforcing agent, etc, for enhancing lubricity, heat stability, transparency and intensity of plastic, respectively.

Among them, the heat stabilizer is used to prevent the resins from deterioration when exposing to heat. The heat stabilizer can be roughly classified into metallic compound stabilizer and organic compound stabilizer. Usually, the most commonly used heat stabilizer for the resin is the metallic compound stabilizer, while the organic compound stabilizer is usually used in conjunction with the metallic compound stabilizer.

The metallic compound stabilizer can be categorized into tin, zinc, barium/cadmium and calcium/zinc types compounds according to the metal species contain therein. All of these metallic compounds can inhibit the decomposition of the resin by preventing from occurring unstable additive reaction in the resin. Accordingly, the heat stabilizer is selected by consideration of the characteristics of heat stabilizers and end use of the resin products. For example, although zincic heat stabilizer enhances the heat stability of resin, it would also reduce the transparency of the resin, so that it is usually used in the products which transparency is not necessary; the calcium/zincic heat stabilizer is usually used in producing medical equipment and pharmaceutical packaging due to its low toxicity; and the tin heat stabilizer is often used in food packaging industries due to its low toxicity and high transparency.

The commonly used organic compound heat stabilizers, such as diphenyl isodecyl phosphite, dialkyl pentaerythritol diphosphite, etc, are added into the resin along with the metallic compound heat stabilizer. However, phenols contained in the organic compound will volatilize and then condense on the surface of the products produced therefrom and results in “haze.” In addition, if the resin added with the phosphites is used in food packaging or medical equipment, the released phenols will contaminate the packaging or equipment and thus harm the human beings. This is one of the reasons why the organic compound heat stabilizer should be used in conjunction with the metallic compound heat stabilizer in order to reduce the amount of the organic compound heat stabilizer and thus reduce the amount of the volatilized phenol.

U.S. Pat. No. 3,281,381 discloses a process for preparing phosphites by the transesterification between triphenyl phosphite and pentaerythritol and the use of the phosphites as heat stabilizer. However, the phosphites still contain free and bound phenols so that when adding the phosphite into resin, the phenol still volatilizes and results in adverse effects on products prepared.

U.S. Pat. No. 3,205,250 discloses heat stabilizers-dialkyl pentaerythritol diphosphites. The dialkylpentaerythritol diphosphites are prepared by reacting dialkyl alcohol with diphenylpentaerythritol diphosphite or dichloropentaerythritol diphosphite. When using dichloropentaerythritol diphosphite to substitute for diphenylpentaerythritol diphosphite, the amount of the generated phenol would be reduced during the preparation. However, the resultant diphosphites in '250 patent are usually solid at room temperature so that the use of the diphosphites in resin is significantly limited.

In addition, a process for preparing dialkylpentaerythritol diphosphites without occurring of free phenol is disclosed in U.S. Pat. No. 4,290,976. In the process, since the dichloropentaerythritol diphosphite is made from pentaerythritol and phosphorous trichloride having no phenols functionality, no phenol will be formed to contaminate the product. However, the freezing points of the dialkylpentaerythritol diphosphites is high and thus could not be well mixed with liquid stabilized by metallic compound to form a homogenous mixture, so that use of the dialkylpentaerythritol diphosphites as heat stabilizer is still limited.

U.S. Pat. No. 3,047,608 discloses a process for preparing trialkyl phosphites and dialkyl pentaerythritol diphosphites by transesterification from triphenyl phosphite using a dialkyl or diphenyl phosphite as a catalyst. In the process, the by-product phenol is removed by addition of excess higher aliphatic alcohol and distillation under vacuum. However, the trialkyl phosphite is incompatible with liquid stabilized by metallic compound, and thus use of the trialkyl phosphites as a heat stabilizer for PVC is also limited.

Accordingly, there remains a need and further development for phenol-free phosphites as heat stabilizer and the preparation thereof.

### SUMMARY OF THE INVENTION

In view of the shortcomings of the current phenol-free phosphite and preparation thereof, the inventors have conducted an investigation on the manufacturing process for preparing phenol-free phosphate and thus completed the invention.

Therefore, one aspect of the present invention is to provide a method for producing a low phenol or phenol-free phosphite derivative having the following formula (I),

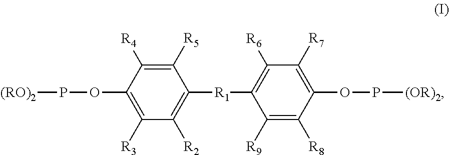

(wherein: R is C₈₋₂₀ aliphatic hydrocarbyl group, R₁ is a chemical bond, —S—, —CH₂SCH₂— or C₁₋₆ alkylene, and R₂-R₉ are the same or different and each independently represents H or C₁₋₇ alkyl);
which method comprises the steps of: reacting (a) a bisphenol compound having the following formula (II):

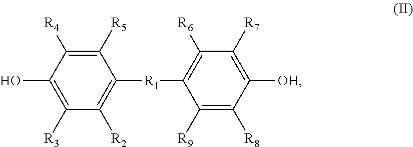

(wherein R, and R₁-R₉ are defined as above);

with (b) a phosphorus derivative having the formula (III): PX₃ (III) (wherin X is halogen, —O—C₁₋₇ alkyl or —O-aryl), and (c) an alcohol compound having the formula (IV): ROH (IV) (wherein R is defined as above) under an elevated temperature condition to conduct addition reaction and transesterification reaction, to obtain the phosphite of formula (I) containing residual phenol of not more than 0.5 wt % or nil.

According to the method described above, the phosphite derivative is represented by the following formula (I′):

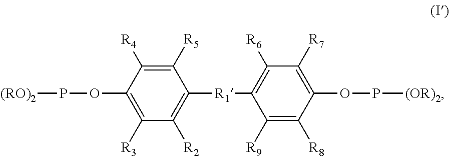

wherein:

R is C₈₋₂₀ aliphatic hydrocarbyl group,

R₁′ is a chemical bond, —S—, or —CH₂SCH₂—, and

R₂-R₉ are the same or different and each independently represents H or C₁₋₇ alkyl,

wherein the phosphite of formula (I′) containing residual phenol of not more than 0.5 wt % or nil.

In addition, another aspect of the present invention is to provide a low phenol or phenol-free phosphite derivative having the following formula (I′):

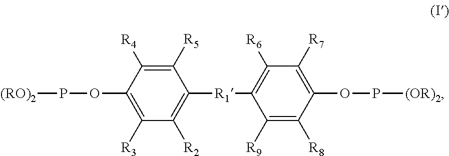

wherein:

R is C₈₋₂₀ aliphatic hydrocarbyl group,

R₁′ is a chemical bond, —S—, or —CH₂SCH₂—, and

R₂-R₉ are the same or different and each independently represents H or C₁₋₇ alkyl,

wherein the phosphite derivative of formula (I′) containing residual phenol of not more than 0.5 wt % or nil.

Another aspect of the present invention is to provide a use of the low phenol or phenol-free phosphite derivative of the above formula (I′), which is used as a heat stabilizer for resin.

### DETAILED DESCRIPTION OF THE INVENTION

Term Definition

The terms used in the specification generally have their ordinary meanings in the art, within the context of the invention, and in the specific context where each term is used. Certain terms that are used to describe the invention are discussed below. Unless otherwise defined, all technical and scientific terms used herein have the same meaning as commonly understood by one of ordinary skill in the art to which the invention pertains. In the case of conflict, the present specification, including definitions will control.

As used herein, the term “phenol-free” refers to the phosphite, which is synthesized according to the method of the present invention, having no phenol residue. Therefore, when the phosphite is used as a heat stabilizer in the resin, there is no detectable phenol level in the final resin product.

As used herein, the term “low phenol” refers to the phosphite, which is synthesized according to the method of the present invention, having 0.5 wt % or 0.3 wt % or less, or less than the detectable limit of the detection method, preferably nil, phenol remaining in the phosphite. In addition, when the phosphite is used as a heat stabilizer in the resin, there is no detectable phenol level in the final resin product.

As used herein, the term “C₁₋₆ alkylene” refers to a saturated divalent hydrocarbyl group having 1 to 6 carbon atoms, and is a residual derived from removing two hydrogen atoms from the same or different carbon atom(s) of a straight or branched hydrocarbon. Examples of C₁₋₆ alkylene include methylene, ethylene, ethylidene, n-propylene, isopropylene, isopropylidene, n-butylene, isobutylene, n-butylidene, pentamethylene, hexamethylene, etc. The preferable alkylene having 1 to 6 carbons are as below:

—CH₂—; CH₃(CH₂)ₙ₌₁₋₃CH<.

As used herein, the term “bisphenol compound” refers to a compound having two phenol functional groups, represented by the following general formula:

HO—Ar—Y—Ar—OH,

wherein Ar is aryl, optionally substituted by C₁₋₇ alkyl; Y is a linking nucleus, and represents a chemical bond, —S—, —CH₂SCH₂—, or C₁₋₆ alkylene.

As used herein, the term “chemical bond” means that the two elements on the both ends of the bond are directly bonded, for example, if Y represents a chemical bond, the both Ar groups on both sides of the Y are directly bonded.

As used herein, the term “higher aliphatic alcohol” refers to monohydric alcohol having at least 6 carbon atoms, preferably having 8 to 20 carbon atoms, and more preferably having 12 to 15 carbon atoms. The alcohol can be used in one kind or a mixture of two or more kinds.

As used herein, the term “alkyl” refers to a linear or branched monovalent saturated hydrocarbon group, consisting of only carbon and hydrogen atoms and having 1 to 7 carbon atoms (i.e. C₁₋₇ alkyl). Examples of the alkyl includes, but not limited to, methyl, ethyl, n-propyl, isopropyl, butyl, isobutyl, sec-butyl, tert-butyl, pentyl, n-hexyl, and heptyl etc.

As used herein, the term “aryl” refers to an aromatic monocyclic or multicyclic ring system, having 6 to 14 carbon atoms, preferably 6 carbon atoms. Examples of the aryl include phenyl group, naphthyl group, anthracene, etc.

As used herein, the term “aliphatic hydrocarbyl group” refers to a non-aromatic hydrocarbyl group, such as alkyl, alkenyl or alkynyl in a straight chain, a branched chain or a cyclic arrangement or a combination thereof. Preferable the aliphatic group contains 8 to 20 carbon atoms.

As used herein, the term “halogen” refers to F, Cl, Br, or I; preferably Cl.

Method for Producing a Low Phenol or Phenol-Free Phosphite Derivative

The present invention provides a method for producing a low phenol or phenol-free phosphite derivative having the following formula (I),

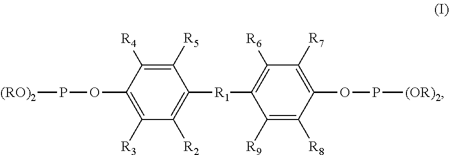

(wherein: R is a C₈₋₂₀ aliphatic hydrocarbyl group, R₁ is a chemical bond, —S—, —CH₂SCH₂— or C₁₋₆ alkylene, and R₂-R₉ are the same or different and each independently represents H or C₁₋₇ alkyl);
which comprises the steps of: reacting (a) a bisphenol compound having the following formula (II):

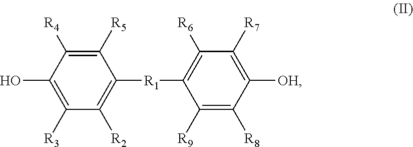

(wherein R, and R₁-R₉ are defined as above);

with (b) a phosphorus derivative having the formula: PX₃ (III) (wherin X is a halogen, —O—C₁₋₇ alkyl or —O-aryl), and (c) an alcohol compound having the formula: ROH (IV) (wherein R is defined as above) at an elevated temperature to conduct an addition reaction and a transesterification reaction both, to produce a phosphite derivative of formula (I) having residual phenol level of not more than 0.5 wt % or nil.

In the above mentioned method of the present invention, the bisphenol compound of formula (II) first reacts with the phosphorus derivative of formula (III) to conduct an addition reaction, and the resultant addition product then reacts with the alcohol compound of formula (IV) to conduct a transesterification reaction.

In the above mentioned method, the bisphenol compound includes, but not limited to, bisphenol A (also known as 2,2′-bis(4-hydroxyphenyl)propane), bisphenol F (also known as 2,2′-bis(4-hydroxyphenyl)hexafluoropropane), bisphenol F (also known as bis(4-hydroxyphenyl)methane), 4,4′-thio-bis(6-tert-butyl-m-cresol), compounds of 4,4′-thio-bis(dialkylphenol), such as 4,4′-thio-bis(3-methyl-6-tert-butylphenol), 4,4′-thio-bis(3,6-di-tert-butylphenol), 4,4′-thio-bis(3-methyl-6-isopropylphenol), 4,4′-thio-bis(3-propyl-6-tert-butylphenol), 4,4′-thio-bis(6-tert-butylphenol), etc.

In the above mentioned method, examples of the phosphorus derivative having the formula: PX₃ (III) in which X is —O—C₁₋₇ alkyl or —O-aryl include, but not limited to trimethyl phosphite, triethyl phosphite, tripropyl phosphite, triisopropyl phosphite, tributyl phosphite, tripentyl phosphite, trihexyl phosphite or triphenyl phosphite. The preferred phosphorus derivative is triphenyl phosphite. Examples of the phosphorous derivative in which X is halogen include, but not limited to, phosphorous trifluoride, phosphorous trichloride, phosphorous tribromide, phosphorous triiodide. The preferred phosphorus derivative is phosphorous trichloride.

In the above mentioned method, examples of the alcohol compound having the formula: ROH (IV) include, but not limited to, octanol, nonanol, decanol, stearyl alcohol, isostearyl alcohol, cetyl alcohol, palmityl alcohol, myristic alcohol, behenyl alcohol, etc. The alcohol can be used in one kind or a mixture of two or more kinds.

In the above mentioned method, the molar ratio of the bisphenol compound of formula (II) to the phosphorus derivative of formula (III) to the alcohol compound of formula (IV) can vary over a wide range but generally is from 1:1˜5:2˜10 (the bisphenol compound of formula (II):the phosphorus derivative of formula (III):the alcohol compound of formula (IV)), preferably from 1:1˜2:2˜4, and more preferably 1:1:4 or 1:2:4.

In the above mentioned method, the bisphenol compound of formula (II), the phosphorus derivative of formula (III) and the alcohol compound of formula (IV) are directly mixed optionally in the presence of catalyst and heated at a temperature of from about 80° C. to 180° C., preferably from about 120° C. to 170° C., more preferably from about 130° C. to 150° C. The phenol will be distilled off if it occurs in the reaction system. If the reaction is carried out at a temperature of above 130° C. under a vacuum, the occurred phenol would escape and thus facilitate the reaction's completion.

In addition, in the above mentioned method, the most convenient way is mix the bisphenol compound of formula (II), the phosphorus derivative of formula (III) and the alcohol compound of formula (IV) at the same time to obtain the phosphite derivatives of the present invention. However, the method can be conducted first by reacting the bisphenol compound of formula (II) with the phosphorus derivative of formula (III) to give an intermediate of formula (V),

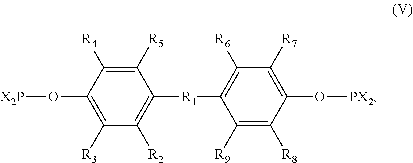

wherein: R is C₈₋₂₀ aliphatic hydrocarbyl group; R₁ is a chemical bond, —S—, —CH₂SCH₂— or C₁₋₆ alkylene; R₂-R₉ are the same or different and each independently represents H or C₁₋₇ alkyl; and X is halogen, —O—C₁₋₇ alkyl or —O-aryl. Then, the resultant intermediate of formula (V) further reacts with the alcohol compound of formula (IV) to give the phosphite derivative of the present invention.

In the method of the present invention, it can also be conducted in the presence of a catalyst including an acid or a base catalyst. Examples of the acid catalyst include, but not limited to, diphenyl phosphite, didecyl phosphite, phenyl decyl phosphite, di(2-methylphenyl)phosphite, di(3-methylphenyl) phosphite, di(4-methylphenyl) phosphite, di(4-dodecylphenyl)phosphite, di(2,4-dimethylphenyl)phosphite, di(2-chlorophenyl)phosphite, di(4-bromophenyl)phosphite, di(3 -iodophenyl)phosphite, di(2-fluorophenyl)phosphite, dimethyl phosphite, dihexyl phosphite, dicyclohexyl phosphite, dioctyl phosphite, dioctadecyl phosphite, dilauryl phosphite and dichloroethyl phosphite, preferably diphenyl phosphite. Examples of the base catalyst include, but not limited to, trimethylamine, triethylamine, triethanolamine, alkali metal or alkaline earth metal: alkali metal or alkaline earth metal hydroxide, such as sodium hydroxide, potassium hydroxide, calcium hydroxide, barium hydroxide, strontium hydroxide, etc.; alkaline earth metal oxide such as calcium oxide, barium oxide, strontium oxide, etc.; alkali metal or alkaline earth metal alkoxide, such as sodium methoxide, sodium ethoxide, sodium isopropoxide, etc.; alkali metal or alkaline earth metal carbonate, such as lithium carbonate, sodium carbonate, potassium carbonate, calcium carbonate, barium carbonate, etc. The catalyst is preferably selected from triethylamine, sodium methoxide, sodium hydroxide, potassium hydroxide, sodium carbonate, potassium carbonate, calcium carbonate or lithium carbonate. Under this circumstance, the catalyst is used in a catalytic amount, preferably from 0.01 to 2 percent by weight of the phosphorus derivative of formula (III).

In a preferable embodiment, the present invention is to provide a method for producing a low phenol or phenol-free phosphite derivative having the following formula (I′):

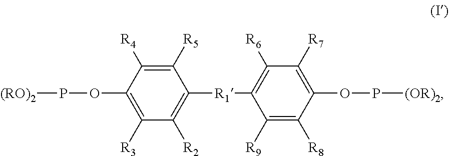

wherein:

R is C₈₋₂₀ aliphatic hydrocarbyl group; R₁′ is a chemical bond, —S—, or —CH₂SCH₂—; and R₂-R₉ are the same or different and each independently represents H or C₁₋₇ alkyl, and wherein the phosphite of formula (I′) contains residual phenol level of less than 0.5 wt % or nil.

The low Phenol or Phenol-Free Phosphite Derivative of the Present Invention

Another aspect of the present invention is to provide a low phenol or phenol-free phosphite derivative having the following formula (I′) (hereinafter briefly referred to “the phosphite derivative”):

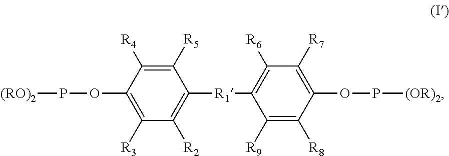

wherein: R is C₈₋₂₀ aliphatic hydrocarbyl group; R₁′ is a chemical bond, —S—, or —CH₂SCH₂—; and R₂-R₉ are the same or different and each independently represents H or C₁₋₇ alkyl, and wherein the phosphite derivative of formula (I′) contains a residual phenol level of less than 0.5 wt % or nil.

In a preferable embodiment of the present invention, R is C₉₋₁₇ aliphatic hydrocarbyl group; R₁′ is —S— and R₂-R₉ are the same or different and each independently represents H or C₁₋₇ alkyl. In a more preferable embodiment of the present invention, R is C₁₂₋₁₅ aliphatic hydrocarbyl group; R₁′ is —S— and R₂-R₉ are the same or different and each independently represents H or C₁₋₇ alkyl. The low phenol or phenol-free phosphite derivative of formula (I′) is prepared by the above mentioned method of the present invention, and is a liquid at room temperature, preferably the phosphite derivative contains no phenol.

Use of the Low Phenol or Phenol-Free Phosphite Derivative of the Present Invention

Another aspect of the present invention is to provide a use of the low phenol or phenol-free phosphite derivative of the above formula (I′), which is used as a heat stabilizer for resin.

The resins to be stabilized by present phosphite derivative of formula (I′) include, but not limited to, polyvinyl chloride (PVC), styrene-isoprene-styrene (SIS) elastomer, styrene-butadiene-styrene (SBS) elastomer, styrene-ethylene-butylene-styrene (SEBS) elastomer, polypropene (PP), high-density polyethylene (HDPE), low-density polyethylene (LDPE), linear low-density polyethylene (LLDPE), high impact polystyrene(HIPS), acrylonitrile-butadiene-styrene (ABS), polybutylene terephthalate (PBT), polycarbonate (PC), polyamide (PA), polyurethanes (PU), etc.

When the phosphite derivative of formula (I′) of the present invention is used as a heat stabilizer for resins, it is desirable to blend with other metallic heat stabilizers, preferably liquid metallic heat stabilizers. The metallic heat stabilizers can be those well known in the art, and include, but not limited to, the heat stabilizers of tin, zinc, barium/cadmium and calcium/zinc types. Typical liquid metallic heat stabilizers such as liquid zinc carboxylate (for example, zinc 2-ethylhexanoate), which is compatible with the phosphite derivative of the present invention to gives a homogenous composition. In addition, when the phosphite derivative of formula (I′) of the present invention is used as a heat stabilizer for resin, the resin can further be added with other additives, such as lubricants, nucleating agents, plasticizers, fillers, colorants, pigments, reinforcing agents, etc.

When the phosphite derivative of formula (I′) of the present invention is used as a heat stabilizer for resins, the phosphites derivative of formula (I′) of the present invention is generally in an amount of from about 0.5 to about 5 parts by weight, preferably from about 0.6 to about 2 parts by weight, and the most preferably from about 0.6 to about 1.5 parts by weight based on 100 parts by weight of a resin.

When the phosphite derivative of formula (I′) of the present invention is added in resins to give a resin composition, the resin composition could be further processed into molded article by calendering on a two-roll mill at high temperature (such as 220° C.), and the article shows excellent heat stability and discolor resistance, and no residual phenol is detected in the article. It is evident that the phosphite derivative of formula (I′) of the present invention is excellent heat stabilizer for resin. Furthermore, the phosphite derivative of the present invention is liquid at room temperature, so that it shows excellent compatibility when mixed with other metallic heat stabilizers, especially liquid metallic heat stabilizer, and can improve the heat stability of the resin to extend the applications of the resin.

Therefore, another aspect of the present invention is to provide a resin composition, which is characterized by comprising the phosphite derivative of formula (I′) of the present invention.

The following experimental examples are provided in order to demonstrate and further illustrate various aspects of certain embodiments of the present invention and are not to be construed as limiting the scope thereof. Variations and modifications without departing from the spirit are still in the scope of the present invention. The following examples are provided to detail describe the present invention.

### EXAMPLE

### Example 1

### Synthesis of Phenol-free 4,4′-thio-bis(3-methyl-6-tert-butylphenyl)isotridecyl phosphite (Corresponding to the Phosphite Derivative of Formula (I′), Wherein R₁′ is —S—, R₃, R₅, R₆ and R₈ are hydrogen, R₄ and R₇ are methyl, R₇ and R₉ are tert-butyl, and R is tridecyl)

To a glass flask fitted with an agitator, a reflux condenser, and a gas outlet, 179.20 g. (0.5 mole) of 4.4′-thio-bis(6-tert-butyl-m-cresol), 200 g heptane and 400 g toluene were added and then heated to 35° C. After mixing well, 62.6 g of PCl₃ were added and the reaction mixture was heated to about 90° C. After reacting at 90° C. to 95° C. for 0.5 hours, HCl was still found. The reaction was continued for further approximately 1.25 hours at 90° C. to 95° C., followed by cooling to 30° C. Then 220 g (1.1 moles) of isotridecyl alcohol and a solution of 212 g (2.1 moles) of triethyl amine in 1800 ml of toluene were gradually drop added over 1 hour while continuously stirring the mixture at 45° C. to 50° C. The resultant mixture was filtered to remove the triethylamine hydrochloride salt and the filtrate was distilled at a temperature of 150° C. for 20 mm to distill toluene off. Then the residue was stripped in vacuum for 5 hours to yield 400 g of product in clear liquid.

In example 1, the whole reaction system contains no phenol; therefore, the resultant phosphite is a phenol-free phosphite.

### Example 2

### Synthesis of Liquid Low Phenol Phosphite (Corresponding to the Phosphite Derivative of Formula (I), Wherein R₁ is propylidene, R₂ to R₉ are hydrogen and R is C₁₂₋₁₅ alkyl)

To a glass flask fitted with an agitator, a reflux condenser, and a gas outlet, 114.0 g (0.5 mole) of 4,4′-(hydroxyphenol)isopropane, 310.0 g. (1.00 mole) of triphenyl phosphite, 413.7 g. (2.10 moles) of C₁₂₋₁₅ higher aliphatic alcohols (commercial available from Shell Chemical, under a trade name NEODEL 25, or commercial available from SASOL Corporation, under a trade name Lial Chem 25/75) and 1 g of diphenyl phosphite were added and heated to 130° C. for 2 hours and then distilled in vacuum (at a temperature of 150° C. and a pressure of not more than 10 mmHg) for 2 hours to remove byproducts (phenol containing C₁₂₋₁₅ alcohols) and finally cooled to room temperature, to yield 554.7 g of product in clear liquid. The distillate was 283 g (3.0 moles) of phenol containing some C₁₂₋₁₅ alcohols.

### Example 3

### Synthesis of Low Phenol Phosphite (Corresponding to the Phosphite Derivative of Formula (I), Wherein R₁ is propylidene, R₂ to R₉ are hydrogen, and R is decyl)

To a glass flask fitted with an agitator, a reflux condenser, and a gas outlet, 114.0 g (0.5 mole) of 4,4′-(hydroxyphenol)isopropane, 310.0 g (1.00 mole) of triphenyl phosphite, 331.8 g (2.10 moles) of isodecanol and 1 g of sodium methoxide were added and heated to 130° C. for 2 hours. The resultant mixture was distilled in vacuum (at a temperature of 150° C. and a pressure of not more than 10 mmHg) for 2 hours to remove phenol and then cooled, to yield 472.8 g of phosphite of the present invention in clear liquid. The distillate was 283 g (3.0 moles) of phenol containing some decyl alcohols.

### Example 4

### Synthesis of Low Phenol Phosphite (Corresponding to the Phosphite Derivative of Formula (I′), Wherein R₁′ is —S—, to R₈ are hydrogen, R, and R₉ are tert-butyl, and R is C₁₂₋₁₅ alkyl)

To a glass flask fitted with an agitator, reflux condenser, and a gas outlet, 179.20 g (0.5 mole) of 4.4′-thio-bis(6-tert-butyl-m-cresol), 310.0 g (1.00 mole) of triphenyl phosphite, 413.7 g (2.10 moles) of C₁₂₋₁₅ aliphatic alcohols (commercial available from Shell Chemical, under a trade name NEODEL 25, or commercial available from SASOL Corporation, under a trade name Lial Chem 25/75), 1 g of diphenyl phosphite were mixed and heated to 130° C. for 2 hours. The resultant mixture was distilled in vacuum (at a temperature of 150° C. and a pressure of not more than 10 mmHg) for 2 hours then cooled, to yield 619.9 g of phosphite derivative of the present invention in clear liquid. The distillate was 283 g (3.0 moles) of phenol containing some C₁₂₋₁₅ alcohols.

### Example 5

### Testing the Efficiency of the Phenol-Free Phosphite as a Heat Stabilizer

The inventive example-Test of the phenol-free phosphite of example 1 as a heat stabilizer (Sheet A)

PVC formulation: 100.0 g of PVC powder (commercial available from Formosa Plastic Corporation, Taiwan, under a trade name S-70), 40.0 g of DOTP (dioctyl terephthalate) plasticizer (commercial available from ChangChun Plastics. Co. Ltd., D-810), 2.0 g of ESBO (epoxidized soyabean oil) (commercial available from ChangChun PetroChemical, Co. Ltd.), 2.0 g of SC-23 (non-Toxic Ca/Zn stabilizer) (commercial available from ChangChun Plastics. Co. Ltd.).

[Heat Resistance Test]

The above PVC formulation was added with 1 g of the phenol-free phosphite of example 1, and the mixture was blended and cast into a film with heating at 170° C. for 4 minutes and then calendered on a two-roll mill at 170° C. and a pressing pressure of 100 kg/cm² for 5 mins to give a sheet having a thickness of 0.7″ (“the present sheet”). The yellow index (YI) of the resultant sheet was tested and found to be 3.8, which is referred to “initial color”. Then the sheets were put into an oven at a temperature of 175° C. for 15 mins and 30 mins, respectively. The yellow index (YI) of the sheet after heating for 15 mins and 30 mins was also tested and referred as a yellow index difference (ΔYI) by comparing with the above initial color. The results were shown in Table 1.

Also, the sheets were continued heating at 175° C. and determined the time by terms of minute when the color of the sheet become brown-black. The time was referred to “heat deteriorating time”. The results were also shown in Table 1.

### Comparative Example

### Test of Diphenyl Isodecyl Phosphite as a Heat Stabilizer (Sheet B)

The formulation and the calendering condition were the same as described in “the present example” except substituting 1.0 g of diphenyl isodecyl phosphite for 1.0 g of the phenol-free phosphite to give a sheet having a thickness of 0.7″ (“the comparative sheet”). The initial color of the Comparative sheet was found to be 5.4. The heat resistance and the heat deteriorating time of the comparative sheets were tested similar to the mentioned above. The results were shown in Table 1.

Comparison of heat resistance of the present sheet and the Comparative sheet

TABLE 1

| | | The present | Comparative |
|---|---|---|---|
| | | sheet | sheet |
| Heat resistance in | After heating for 15 | ΔYI = 2.6 | ΔYI = 3.1 |
| terms of yellow index | mins | | |
| difference | After heating for 30 | ΔYI = 5.7 | ΔYI = 8.0 |
| | mins | | |

| | | |
|---|---|---|
| Heat deteriorating time (mins) | 112 | 95 |

From the data shown in Table 1, it is known that the heat resistance, including yellowing and heat deteriorating time, of the PVC sheet added with the phosphite of the present invention as a heat stabilizer is superior over the one added with a commercial available heat stabilizer, i.e. diphenyl isodecyl phosphite.

### Example 6

### Determining the Residual Phenol Level in the Phosphite (by Sampling the Gas Overhead and Analyzing by GC/MS)

The residual phenol level of phosphites derivative of Examples 1 to 4 was analyzed according to US EPA 5021 standard method by sampling the gas overhead and analyzing by GC/MS (column HP-5, carrier gas, He). The phenol level of phosphites derivative of Examples 1 to 4 were shown in Table 2:

TABLE 2

| | Example 1 | Example 2 | Example 3 | Example 4 |
|---|---|---|---|---|
| Phenol level % | Nil | 0.02 | 0.03 | 0.01 |

### Example 7

### Determining the Residual Phenol Level in the Product Prepared From the Resins Added With Phosphate as a Heat Stabilizer (by Sampling the Gas Overhead and Analyzing by GC/MS)

Phosphite derivatives of Examples 1 to 4 were each blended with polyvinyl chloride resin to form a sheet by using the following formulation and production process. 100 Parts by weight of PVC (commercial available from Formosa Plastics Corporation under trade name S-65) was blended 40 parts by weight of dioctyl terephthalate (DOP), 2 parts by weight of epoxidized soyabean oil (ESBO), 1.2 parts by weight of Ca/Zn stabilizer and 0.6 parts by weight of the phosphites derivative of each Examples 1 to 4, and the mixture was calendered on a two-roll mill at 220° C. for 5 minutes to give a plastic sheet having a thickness of 0.33″.

The residual phenol level of the plastic sheet was analyzed according to US EPA 5021 standard method as below. The sheet was cut into 2 mm×2 mm pieces, and 0.5 g of the pieces was weighted and loaded into the headspace sample vial, heated to 90° C. for 45 minutes. The gas overhead in the vial was sampled and analyzed by GC/MS (column HP-5, carrier gas, He). The results were shown in Table 3:

TABLE 3

| | Example 1 | Example 2 | Example 3 | Example 4 |
|---|---|---|---|---|
| Phenol level % | Nil | nil | nil | nil |

### Example 8

### Determining the Residual Phenol Level in the Product Prepared From the Resins Added With Phosphate as a Heat Stabilizer (by Sampling the Gas Overhead and Analyzing by GC/MS)

0.6 Parts by weight of phosphite derivative of Examples 1 to 4 were each blended with 100 parts by weight of styrene-butadiene-styrene resin (polymer structure is a linear type; butadiene vs styrene ratio is 71/29 and di-block ration is 18%) (styrene- butadiene copolymer), and the mixture was calendered on a heat press mill at 260° C. for 5 minutes to give plastic sheet having a thickness of 0.33″.

The residual phenol level of the plastic sheet was analyzed according to US EPA 5021 standard method as below. The sheet was cut into 2 mm×2 mm pieces, and 0.5 g of the pieces were weighted and loaded into the headspace sample vial, and then heated to 90° C. for 45 minutes. The gas overhead in the vial was sampled and analyzed by head space GC/MS (column HP-5, carrier gas, He). The results were shown in Table 4:

TABLE 4

| | Example 1 | Example 2 | Example 3 | Example 4 |
|---|---|---|---|---|
| Phenol level % | Nil | nil | nil | nil |

### Example 9

### Determining the Residual Phenol Level in the Product Prepared From the Resins Added With Phosphate as a Heat Stabilizer (via KOH Method)

0.6 Parts by weight of phosphite derivative of Examples 1 to 4 were each blended with 100 parts by weight of styrene-butadiene-styrene resin (polymer structure is a linear type; butadiene vs styrene ratio is 71/29; diblock ration is 18%), and the mixture was calendered on a heat press mill at 260° C. for 5 minutes to give a plastic sheet having a thickness of 0.33″.

The phenol level in the sheet was measured by the KOH method as below. The sheet was cut into 2 mm×2 mm pieces, and 0.5 g of the pieces and 0.5N KOH aqueous solution were added into a vessel. The vessel was heated in a mantle equipped with reflux extraction equipment for 15 hours to extract the phenol from the sheet and then cooled down to room temperature. 10 ml of KOH extracted solution was taken out and added with 1 ml of acetic anhydride under shaking. Then 10 ml of hexane was added to the mixture with shaking. Some hexane extracted solution was taken out and analyzed by GC/MS (column HP-5, carrier gas, He) to determine the phenol level in the sheet. The results were shown in Table 5:

TABLE 5

| | Example 1 | Example 2 | Example 3 | Example 4 |
|---|---|---|---|---|
| Phenol level % | nil | nil | nil | nil |

From the above Examples, it is well known that, the method of the present invention could produce phosphite derivative containing low phenol (e.g. no more than 5 wt %), even no phenol. In addition, the obtained phosphite derivatives are liquid at room temperature so that they can be mixed well with resin (especially mixed with liquid resin) when using as a heat stabilizer and thus broaden the applications of the resin. Moreover, the phosphite derivative synthesized by the method of the present invention is low phenol or even phenol-free, so that the use of the phosphite derivative prevents the resin products from phenol escaping and thus the resin can be used in various purposes.

1. A method for producing a low phenol or phenol-free phosphite derivative having the following formula (I), 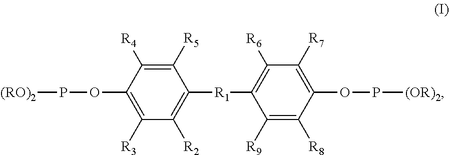
(wherein:
R is C₈₋₂₀ aliphatic hydrocarbyl group,
R₁ is a chemical bond, —S—, —CH₂SCH₂— or C₁₋₆ alkylene,
R₂-R₉ are the same or different and each independently represents H or C₁₋₇ alkyl),
which method comprises the step of:
reacting (a) a bisphenol compound having the following formula (II): 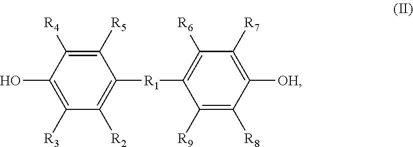
(wherein R₁˜R₉ are defined as above);
with (b) a phosphorus derivative having the following formula (III):
PX₃ (III),
(wherein X is halogen, —O—C₁₋₇ alkyl or —O-aryl,) and
(c) an alcohol compound having the following formula (IV):
ROH (IV),
(wherein R is defined as above)
under an elevated temperature to conduct an addition reaction and a transesterification reaction,
wherein the phosphite of formula (I) contains residual phenol not more than 0.5 wt % or nil.

2. The method according to claim 1, wherein R is C₁₂₋₁₅ aliphatic group.

3. The method according to claim 1, wherein R₁ is —S— or —CH₂SCH₂—.

4. The method according to claim 1, wherein the mole ratio of the bisphenol compound to the phosphorus derivative to the alcohol compound is about 1:1˜2:2˜4 (the bisphenol compound of formula (II):the phosphorus derivative of formula (III):the alcohol compound of formula (IV)).

5. The method according to claim 1, wherein the elevated temperature is from 80° C. to 180° C.

6. The method according to claim 1, where the reaction is carried out in the presence of a catalyst.

7. The method according to claim 6, wherein the catalyst is a base catalyst.

8. The method according to claim 7, wherein the base catalyst is selected from the group consisting of triethylamine, sodium methoxide, sodoum hydroxide, potassium hydroxide, sodium carbonate, potassium carbonate, calcium carbonate and lithium carbonate.

9. The method according to claim 6, wherein the catalyst is an acid catalyst.

10. The method according to claim 9, wherein the acid catalyst is diphenyl phosphite.

11. A low phenol or phenol-free phosphite derivative having the following formula (I′): 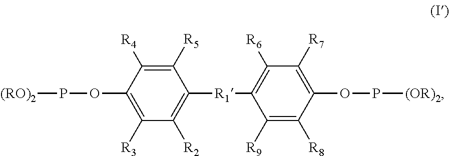
wherein:
R is C₈₋₂₀ aliphatic hydrocarbyl group,
R₁′ is a chemical bond, —S—, or —CH₂SCH₂—,
R₂-R₉ are the same or different and each independently represents H or C₁₋₇ alkyl, and wherein the phosphite of formula (I′) contains residual phenol of not more than 0.5 wt % or nil.

12. The low phenol or phenol-free phosphite derivative according claim 11, wherein R is C₁₂₋₁₅ aliphatic group.

13. The low phenol or phenol-free phosphite derivative according to claim 11, wherein R₁′ is —S— or —CH₂SCH₂—.

14. The low phenol or phenol-free phosphite derivative according to claim 11, which is used as a heat stabilizer for resin.
